(19) United States
(12) Patent Application Publication
(10) Pub. No.: US 2012/0078561 A1
(43) Pub. Date: Mar. 29, 2012

(54) Method for Calibrating a Target Surface of a Position Measurement System, Position Measurement System, and Lithographic Apparatus

(75) Inventors: Paulus Johannes KNIJN, Nijmegen (NL); Christiaan Alexander HOOGENDAM, Westerhoven (NL); Leon Martin LEVASIER, Hedel (NL); Roland BLOK, Eindhoven (NL); Martinus Agnes Willem CUIJPERS, Veldhoven (NL); Martin Frans Pierre SMEETS, Veldhoven (NL)

(73) Assignee: ASML Netherlands B.V., Veldhoven (NL)

(21) Appl. No.: 13/215,620

(22) Filed: Aug. 23, 2011

Related U.S. Application Data
(60) Provisional application No. 61/387,331, filed on Sep. 28, 2010.

(51) Int. Cl. G06F 19/00; G06F 15/00

(52) U.S. Cl. 702/94; 702/150

(57) ABSTRACT

A method is used to calibrate a target surface of a position measurement system configured to measure a position of a movable object. The position measurement system includes the target surface mounted on the movable object, a stationary sensor system, and a processing device to calculate a position of the movable object on the basis of at least one measurement signal of the sensor system. The processing device includes a correction map of the target surface to correct for irregularities of the target surface. The method includes recalibrating the correction map of the target surface by measuring the target surface and determining a recalibrated correction map of the complete target surface on the basis of the measured target surface and one or more deformation modes of the target surface and/or physical objects affecting the target surface.

### CROSS REFERENCE TO RELATED APPLICATIONS

This application claims benefit under 35 U.S.C. §119(e) to U.S. Provisional Application No. 61/387,331, filed Sep. 28, 2010, which is incorporated by reference herein in its entirety.

### BACKGROUND

1. Field of the Invention

The present invention relates to a method for calibrating a target surface of a position measurement system, a position measurement system, and a lithographic apparatus.

2. Description of the Related Art

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti parallel to this direction. It is also possible to transfer the pattern from the patterning device to the substrate by imprinting the pattern onto the substrate.

In the known lithographic apparatus a position measurement system is used for determining the position of a substrate stage with high accuracy (e.g., nanometer accuracy). Due to a continuing demand for higher throughput and increased accuracy, there is a need to improve the accuracy of measurement systems used in the lithographic apparatus, in particular for the measurement systems with which the position of the substrate stage and reticle stage are measured, and typically in six degrees of freedom.

A target surface mounted on the substrate stage can be used as part of the position measurement system. The target surface is arranged to be measured to determine a position of the substrate stage with a stationary sensor system, i.e., a sensor system not mounted on the substrate stage. The sensor system may for instance be mounted on a substantially stationary frame, in particular a so-called metrology frame (metro-frame), or on the projection system of the lithographic apparatus. The stationary sensor system may be an interferometer-type or an encoder-type position measurement system. Usually, the stationary sensor system of an interferometer-type measurement system comprises a light source to provide a measurement beam to be reflected on the target surface. A light sensor of the sensor system is arranged to receive the reflected measurement beam. The reflected measurement beam comprises information on movement of the substrate stage, which for instance may be used by comparison of the signal with a reference beam originating from the light source, but not reflected on the target surface.

A processing device may be provided to calculate a position of the substrate stage on the basis of the reflected measurement beam and the reference beam.

In the position measurement system, it is assumed that the target surface is a perfectly flat surface having equal reflective properties over the complete surface. However, in practice this target surface may have irregularities in shape. From past experience with lithographic systems, it is known to use a correction map e.g., translation-map x,y,z, rotation-map, grid-map, exposure-map or any other machine constant considered for the position measurement system in the position measurement system to correct for irregularities in the target surface. This correction map is obtained by calibration of the target surface. Calibration of the target surfaces may be very time consuming.

Normally, such a series of calibration steps is performed during a full calibration setup sequence of calibration procedures of the apparatus, before the actual use of the lithographic apparatus. However, it may be possible that a calibration is required during a production run of the lithographic apparatus, for instance after a crash of the substrate stage. Such a crash could occur several times per day, and may result in a deformation of the target surface, such as a deformation of a mirror block of the substrate stage. Since such deformation may have substantial influence on the overlay performance of the lithographic process, a re-calibration may be required. As discussed above, such re-calibration is time-consuming, and may for instance take one to three hours. Thus, this recalibration uses valuable production time which is undesirable.

### SUMMARY

It is desirable to provide a method for (re-)calibrating a target surface of a position measurement system, where calibration may be performed in an efficient manner. Further, it is desirable to provide a position measurement system and a lithographic apparatus having such position measurement system, where the position measurement system is capable of performing an efficient (re-)calibration of a target surface of the position measurement system.

According to an embodiment of the present invention, there is provided a method for calibrating a target surface of a position measurement system configured to measure a position of a movable object. The position measurement system comprises the target surface mounted on the movable object, a stationary sensor system, and a processing device to calculate a position of the movable object on the basis of at least one measurement signal of the sensor system. The processing device comprises a correction map of the target surface to correct for irregularities of the target surface. The method comprises recalibrating the correction map of the target surface by measuring the target surface and determining a recalibrated correction map of the complete target surface on the basis of the measured target surface and one or more deformation modes of the target surface and/or physical objects affecting the target surface.

According to another embodiment of the present invention, there is provided a position measurement system to measure a position of a movable object comprising a stationary sensor system and a target surface mounted on the movable object. The stationary sensor system is configured to provide a measurement beam to be reflected on the target surface, to receive the reflected measurement beam, and to provide a measurement signal on the basis of the reflected measurement beam. A processing device calculates a position of the movable object on the basis of at least one measurement signal of the sensor system. The processing device comprises a correction map of the target surface to correct for irregularities of the target surface. The processing device is configured to recalculate or adjust the error map on the basis of measurement of the target surface and determination of a recalibrated correction map on the basis of the measured target surface and one or more deformation modes of the target surface and/or physical objects affecting the target surface.

According to a further embodiment of the present invention, there is provided a lithographic apparatus comprising an illumination system configured to condition a radiation beam, a support constructed to support a patterning device, the patterning device being capable of imparting the radiation beam with a pattern in its cross-section to form a patterned radiation beam, a substrate table constructed to hold a substrate, and a projection system configured to project the patterned radiation beam onto a target portion of the substrate. The lithographic apparatus comprises a position measurement system to measure a position of a movable object comprising a stationary sensor system and a target surface mounted on the movable object. The stationary sensor system is configured to provide a measurement beam to be reflected on the target surface, to receive the reflected measurement beam, and to provide a measurement signal on the basis of the reflected measurement beam. A processing device calculates a position of the movable object on the basis of at least one measurement signal of the sensor system. The processing device comprises a correction map of the target surface to correct for irregularities of the target surface. The processing device is configured to recalculate or adjust the error map on the basis of measurement of the target surface and determination of a recalibrated correction map on the basis of the measured target surface and one or more deformation modes of the target surface and/or physical objects affecting the target surface.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a lithographic apparatus according to an embodiment of the invention.

FIG. 2 depicts schematically a position control system of an embodiment of the invention.

FIGS. 3a and 3b show schematically a stage before and after deformation.

FIGS. 4a and 4b show a schematic sideview in the Y/Z-plane and X/Z-plane of the stage respectively.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

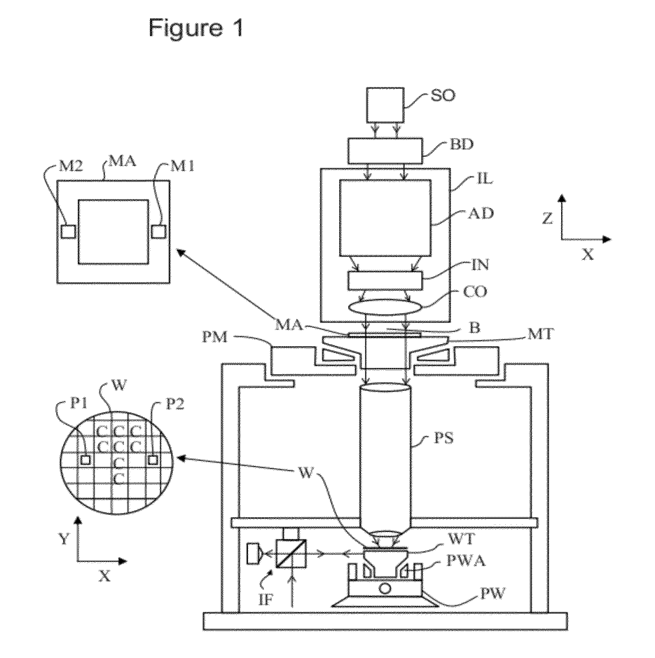

FIG. 1 schematically depicts a lithographic apparatus according to one embodiment of the invention. The apparatus includes an illumination system (illuminator) IL configured to condition a radiation beam B (e.g., UV radiation or any other suitable radiation), a mask support structure (e.g., a mask table) MT constructed to support a patterning device (e.g., a mask) MA and connected to a first positioning device PM configured to accurately position the patterning device in accordance with certain parameters. The apparatus also includes a substrate table (e.g., a wafer table) WT or “substrate support” constructed to hold a substrate (e.g., a resist coated wafer) W and connected to a second positioning device PW configured to accurately position the substrate in accordance with certain parameters. The apparatus further includes a projection system (e.g., a refractive projection lens system) PS configured to project a pattern imparted to the radiation beam B by patterning device MA onto a target portion C (e.g., including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The mask support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The mask support structure can use mechanical, vacuum, electrostatic or other clamping techniques to hold the patterning device. The mask support structure may be a frame or a table, for example, which may be fixed or movable as required. The mask support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross section.

The radiation beam B is incident on the patterning device (e.g., mask MA), which is held on the mask support structure (e.g., mask table MT), and is patterned by the patterning device. Having traversed the mask MA, the radiation beam B passes through the projection system PS, which focuses the beam onto a target portion C of the substrate W. With the aid of the second positioning device PW and position sensor IF (e.g., an interferometric device, linear encoder or capacitive sensor), the substrate table WT can be moved accurately, e.g., so as to position different target portions C in the path of the radiation beam B. Similarly, the first positioning device PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT or “mask support” and the substrate table WT or “substrate support” are kept essentially stationary, while an entire pattern imparted to the radiation beam is projected onto a target portion C at one time (i.e., a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the mask table MT or “mask support” and the substrate table WT or “substrate support” are scanned synchronously while a pattern imparted to the radiation beam is projected onto a target portion C (i.e., a single dynamic exposure). The velocity and direction of the substrate table WT or “substrate support” relative to the mask table MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

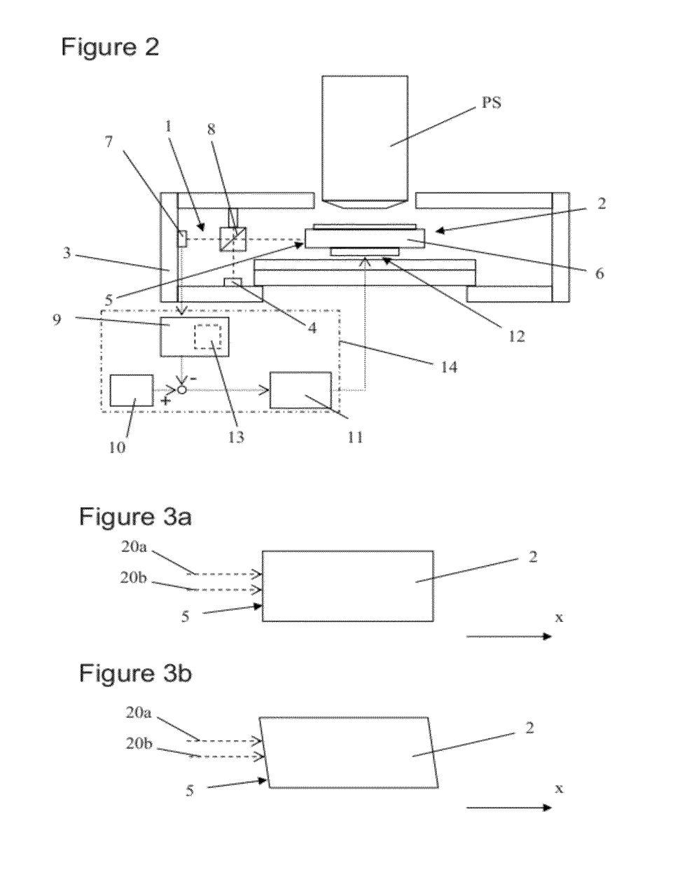

FIG. 2 shows a position measurement system, generally indicated by reference numeral 1, to measure a position of a substrate stage 2. The position measurement system 1 is an interferometer position measurement system comprising a sensor system mounted on a stationary frame 3 of the lithographic apparatus. The term “stationary” is used in this application to indicate that the sensor system does not move along with the substrate stage 2. The term “stationary” does not require that the sensor system remains completely at the same position. For instance, the sensor system may be mounted on a projection system PS which may slightly move with respect to the metrology frame 3.

The sensor system comprises a light source 4 which provides a measurement beam which is directed towards a target surface in the form of a reflective surface 5 mounted on the substrate stage 2. In this embodiment, the reflective surface 5 is arranged on a mirror block 6 of the substrate stage 2. In other embodiments, the reflective surface 5 may be arranged on a separate mirror element of the measurement system, for instance a grid plate, which is mounted on the substrate stage 2.

The reflective surface 5 may reflect the measurement signal to a light sensor 7 of the sensor system, which light sensor 7 provides a measurement signal related to a position quantity of the substrate stage.

In an interferometer measurement system the reflected measurement beam is combined with a reference beam directly originating from the light source 4. For this reason a semitransparent mirror 8 is provided in the path of the beam originating for the light source 4. This semi-transparent mirror 8 divides the light beam in a measurement beam and a reference beam. After reflection on the reflective surface 5, the measurement beam and the reference beam are combined to a combined light beam having intensity differences which are representative for changes in position of the substrate stage 2.

In various examples, the light source 4, light sensor 7 and/or the semi-transparent mirror 8 may be integrated in a single device, or be provided as separate devices as shown in FIG. 2.

The combined light beam is used as input for the light sensor 7 to obtain a measurement signal representative for a position of the substrate stage 2. A processing device 9 is provided to calculate a position of the substrate stage 2 on the basis of the measurement signal received by the light sensor 7.

In a comparator, this measured position may be subtracted from a set-point position originating from a set-point generator 10. The difference between the actual measured position and the set-point position can be used as an input for a control device 11 that provides a control signal which is fed to an actuator system 12 of the substrate stage 2 to move the substrate stage 2 to the desired position.

The above position measurement system 1 is described for one degree of freedom. In one example, the position measurement system 1 is configured to determine a position of the substrate stage 2 in multiple, typically six degrees of freedom, on the basis of which the substrate stage 2 is moved to a desired position. Usually, the position measurement system 1 may have multiple reflective surfaces to make determination of the position of the substrate stage 2 in multiple directions possible.

In one example, the processing device 9 may be a stand alone device, possibly integrated in the light sensor 7. However, the processing device 9 may also incorporate the other elements of the position control system, such as the set-point generator 8, the comparator, and the control device 11, as indicated in FIG. 2 by a box 14. The processing device 9 may be part of a main processor of the lithographic apparatus, or a device dedicated to position control of the substrate stage 2, or may be integrated in any other suitable device.

The reflective surface 5 of the position measurement system may not be perfectly flat. If there is no compensation for any irregularities of the reflective surface 5 in the measured position, the substrate stage 2 may be moved to an incorrect position, which may have a substantial influence on the overlay of exposures on a substrate supported on the substrate stage 2.

To compensate for the irregularities in the reflective surface 5, a correction map 13 of the reflective surface is provided in the processing device 9. This correction map 13 is used to correct the measurement signal from the light sensor 7 for any known irregularities in the reflective surface 5. Such reflective surface 5 may be calibrated before use of the lithographic apparatus to obtain a correction map 13 representative for the irregularities of the reflective surface 5.

Complete measurement and calibration of the reflective surface 5 and calibration of corresponding exposure positions in relation to the surface may use considerable time, for instance one to three hours for a complete set-up of the position measurement system 1. Normally calibration is performed before actual use of the lithographic apparatus. However, it may be possible that calibration is required during a production run with of the lithographic apparatus, for instance after a crash of the substrate stage 2. Such a crash could occur several times per day, and may result in a deformation of the reflective surface 5, such as a deformation of a mirror block 6 of the substrate stage 2. Since such deformation may have substantial influence on the overlay performance of the lithographic process, re-calibration may be required.

As indicated above, such complete re-calibration is time-consuming, and may for instance take two hours. Thus complete recalibration may use valuable production time.

In one embodiment, a method for time-efficient recalibration of the reflective surface 5 of a position measurement system 1. In one example, a step of recalibrating of the reflective surface 5 is carried out by measuring a part or whole of the reflective surface 5, faster or with reduced spatial resolution, and determining a recalibrated correction map 13 of the complete reflective surface 5 on the basis of the measurement and one or more deformation modes of the reflective surface.

The inventors have found that the mode of deformation of the reflective surface 5 originating from any physically deformed object underneath the surface may be consistent. Such consistent deformation shape of the stage or the reflective surface is referred to as a deformation mode. The deformation mode in the reflective surface itself can be related to the deformations in the glue, stage, etc.

When the deformation mode or deformation modes of the reflective surface 5 are known, measurement of a part of the reflective surface 5 may provide enough information to properly estimate the deformation of the rest of the reflective surface 5. Measurement of a part of the target surface may involve faster measurement or with reduced spatial resolution over the complete target surface. Measurement of only a part of the reflective surface 5 will take substantially less time than complete measurement and complete calibration of the reflective surface 5 and related effects onto exposure positions. Therefore, the recalibration can be performed more efficiently.

In one example, the measurement of the target surface is performed with a redundant position measurement system.

FIG. 3a shows an embodiment having a stage 2 having a reflective surface 5.

Two measurement beams 20a, 20b are used to determine the position of the substrate stage in the x-direction. Each of the measurement beams 20, 20b may be used to measure a position of the stage 2 in the x-direction. Thus, the measurement beams 20a, 20b provide redundant information on the position of the stage 2 respect to the stationary sensor system of the position measurement system. Such redundant position measurement system can be used to measure irregularities of a part of the reflective surface 5 to estimate a map of the complete reflective surface 5 as now will be explained.

FIG. 3b shows an embodiment having a stage 2 with reflective surface 5 after a deformation, for instance caused by a crash of the stage 2 comprising the reflective surface 5. As a result of the crash, the rectangular shape of the stage 2 of FIG. 3a is deformed to a parallelepiped shape as shown in FIG. 3b. Assuming that a crash of the stage 2 will always deform in such parallelepiped shape, measurement of only a part of the reflective surface 5 may be sufficient to estimate the complete reflective surface 5.

Due to the different height positions of the measurement beams 20a and 20b, and the deformed shape of the reflective surface 5, the measurement beams 20, 20b will measure different x-positions of the stage 2. The difference between these measured positions and the height difference between the measurement beams 20a, 20b is a measure for the deformation of the stage 2. Since the deformation mode of the stage 2 is known, the difference in measured positions can be used as amplitude in which the stage is deformed in the deformation mode. As a result, a correction map of the complete reflective surface 5 can be determined on the basis of the measured amplitude and the known deformation mode.

It is remarked that the parallelepiped shape is used as an exemplary example of a possible deformation mode of the substrate stage. In various examples, often other deformation modes may be followed by a substrate stage, such as bending modes or torque modes. These deformation modes may originate from force, stresses in the stage, which may be caused by a repositioning of leaf springs in the stage. Deformation modes may also be based on time effects on coating of the reflective surface 5 and/or glue used in mounting of the reflective surface 5.

Further, also combinations of these different deformation modes may result from crashes or other causes of deformation of the substrate stage 2. On the basis of the measurements of a redundant position measurement system, distinct amplitudes for different deformation modes may be determined, and the corresponding correction map for the reflective surface 5 may be determined on the basis of the different deformation modes and the associated amplitudes.

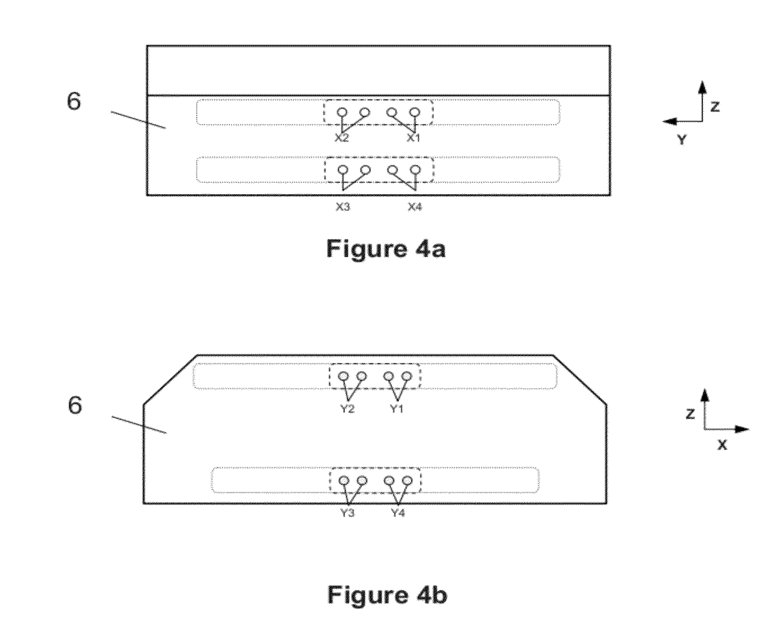

In FIG. 4 an exemplary example of a redundant position measurement system for the Rz measurement of the upper part and the lower part of the substrate table 6 is shown. FIG. 4a shows a schematic side view in the Y/Z-plane of the substrate table 6, including four measurement beams in X-direction (X1, X2, X3 and X4). X1 and X2 are measuring on the upper part of the substrate table 6, whereas X3 and X4 are measuring on the lower part of the substrate table 6. For example, the Rz measurement of the substrate table 6 can be determined based on X1 and X2. FIG. 4b shows a schematic side view in the X/Z-plane of the substrate table 6, including four measurement beams in the Y-direction (Y1, Y2, Y3 and Y4). Y1 and Y2 are measuring on the upper part of the substrate table 6, whereas Y3 and Y4 are measuring on the lower part of the substrate table 6. Consequently the Rz measurement is double redundant for the upper and lower part of the substrate table 6 and allows a reconstruction of the mirror shape of both the upper and lower mirror surfaces as well as the X-beams and the Y-beams.

To use the calibration method of the embodiments of the present invention it may be of importance that the deformation modes of the stage are known. These deformation modes may for instance be obtained by extracting these from a mathematical model of the stage. In an alternative embodiment, the one or more deformation modes may be determined by deliberately deforming the reflective surface of the stage, for instance by crashing the stage, and subsequently measuring a complete map of the respective reflective surface. On the basis of this information one or more deformation modes of the reflective surface resulting from deformation of the stage may be determined.

The calibration method may in particular be performed, when there is a reason to believe that the reflective surface of a position measurement system is deformed, for instance after a crash of a stage. When the stage may deform in multiple deformation modes the step of calculating a correction map for the reflective surface may comprise a selection of at least one relevant deformation mode of the one or more deformation modes on the basis of the measured part of the reflective surface 5. This selection may for instance be based on the type of deformation which is expected. For instance, a crash of the stage will lead to different deformations of the reflective surface than the effect of change in the coating of the reflective surface. When recalibration is performed after a crash of a stage in z-direction, and it is known that such crash typically results in deformation in a bending mode and a torque mode, these modes may be selected as modes for recalibration.

Hereinabove, the use of a redundant interferometer position measurement system is described to determine an amplitude of a deformation of a stage in one or more deformation modes of the stage. To determine this amplitude only a part of the reflective surface of the position measurement system may be determined. These amplitude and the one or more deformation modes are used to estimate a correction of the complete target surface of the position measurement system.

The method may also be used with any other position measurement system having a target surface, in particular an optical position measurement system having a reflective surface mounted on the stage, such as an encoder-type position measurement system to determine a correction map for irregularities of the target surface. For example, the position measurement system is a redundant position measurement system.

The method may also be used in position measurement systems arranged to determine a position of other movable objects, such as a patterning device support. Furthermore, it might comprise a fast recalibration, which can be executed during a production run. This re-calibration might also yield a relation with the deformed stage/surface to new, updated stage exposure or alignment positions.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for calibrating a target surface of a position measurement system configured to measure a position of a movable object, wherein the position measurement system comprises the target surface mounted on the movable object, a stationary sensor system, and a processing device to calculate a position of the movable object on the basis of at least one measurement signal of the sensor system, wherein the processing device comprises a correction map of the target surface to correct for irregularities of the target surface, wherein the method comprises:
recalibrating the correction map of the target surface by measurement of the target surface; and
determining a recalibrated correction map of the complete target surface on the basis of the measured target surface and one or more deformation modes of the target surface or physical objects affecting the target surface.

2. The method of claim 1, wherein the measurement of the target surface comprises measuring a part of the target surface.

3. The method of claim 1, wherein the measured target surface is used to determine an amplitude of deformation in one or more of the deformation modes.

4. The method of claim 1, wherein the measuring the target surface is carried out by the sensor system.

5. The method of claim 1, wherein the measuring the target surface is based on redundant position measurement of the target surface.

6. The method of claim 1, wherein the determining the recalibrated correction map comprises selecting at least one relevant deformation mode of the one or more deformation modes on the basis of the measured target surface.

7. The method of claim 1, wherein the one or more deformation modes are determined by deliberately deforming the target surface and subsequently measuring a complete target surface map, and calculating one or more deformation modes from the complete target surface map.

8. The method of claim 1, wherein the one or more deformation modes are bend modes or torque modes, or based on time effects of coating of the target surface or glue with which the target surface is mounted on the movable object on regularity of the target surface.

9. The method of claim 1, wherein the method is performed after a crash of the movable object.

10. The method of claim 9, wherein the type of the one or more deformation modes used in the calibration is based on a type of crash of the movable object preceding the calibration.

11. The method of claim 1, wherein the movable object is a stage of a lithographic apparatus.

12. Position measurement system to measure a position of a movable object, comprising:
a stationary sensor system,
a target surface mounted on the movable object, wherein the stationary sensor system is configured to provide a measurement beam to be reflected on the target surface, to receive the reflected measurement beam, and to provide a measurement signal on the basis of the reflected measurement beam, and
a processing device to calculate a position of the movable object on the basis of at least one measurement signal of the sensor system, wherein the processing device comprises a correction map of the target surface to correct for irregularities of the target surface,
wherein the processing device is configured to recalculate or adjust the error map on the basis of measurement of the target surface and determination of a recalibrated correction map on the basis of the measured part and one or more deformation modes of the target surface and/or physical objects affecting the target surface.

13. The position measurement system of claim 12, wherein the stationary sensor system is an optical position measurement system, such as an interferometer position measurement system or an encoder position measurement system.

14. The position measurement system of claim 12, wherein the movable object is a stage of a lithographic apparatus.

15. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate,
wherein the lithographic apparatus comprises a position measurement system to measure a position of a movable object, comprising:
a stationary sensor system,
a target surface mounted on the movable object, wherein the stationary sensor system is configured to provide a measurement beam to be reflected on the target surface, to receive the reflected measurement beam, and to provide a measurement signal on the basis of the reflected measurement beam, and
a processing device to calculate a position of the movable object on the basis of at least one measurement signal of the sensor system, wherein the processing device comprises a correction map of the target surface to correct for irregularities of the target surface,
wherein the processing device is configured to recalculate or adjust the error map on the basis of measurement of the target surface and determination of a recalibrated correction map on the basis of the measured target surface and one or more deformation modes of the target surface and/or physical objects affecting the target surface.
